(19) United States
(12) Patent Application Publication
(10) Pub. No.: US 2001/0042228 A1
(43) Pub. Date: Nov. 15, 2001

(54) Memory access system

(75) Inventor: Philippe Klein, La Gaude (FR)

Correspondence Address: Blanche E. Schiller, Esq., HESLIN & ROTHENBERG, P.C., 5 Columbia Circle, Albany, NY, 12203, US

(73) Assignee: International Business Machines Corporation, Armonk, NY (US)

(21) Appl. No.: 09/844,471

(22) Filed: Apr. 27, 2001

(30) Foreign Application Priority Data
May 12, 2000 (EP) 00480039.7

(51) Int. Cl. H04L 1/22

(52) U.S. Cl. 714/48

(57) ABSTRACT

A system for accessing a memory including memorization subsystems, wherein the words to be stored are split up so that several memorization subsystems are used to store one word and its associated Block Error Code (BEC) bits includes logical insulation means and electrical insulation means that are associated to each memorization subsystem. When a memorization subsystem needs to be replaced, e.g. if it is failing, the memory controller insulates this memorization subsystem, the data stored therein are retrieved thanks to the data stored in the other memorization subsystems and thanks to BEC read path function. Thus, when a memorization subsystem is insulated, the computer user can replace this memorization subsystem without losing data and perturbing the computer. After a memorization subsystem has been replaced, its content may be restored using BEC.

### PRIOR FOREIGN APPLICATION

This application claims priority from European patent application number 00480039.7, filed May 12, 2000, which is hereby incorporated herein by reference in its entirety.

### TECHNICAL FIELD

The present invention relates to computer memory systems and more particularly to a memory access system and method which improve the availability of memory systems comprising memorization subsystems and allow a memorization subsystem to be replaced without losing data and perturbing the computer using such memory systems.

### BACKGROUND ART

In today's computers, the memory system is generally made of a plurality of memorization subsystem cards, e.g. Dual In-line Memory Modules (DIMMs). DIMMs are built with several Synchronous Dynamic Random Access Memory (SDRAM) chips, the number of chips depending upon the DIMM memory size, the data bus width, etc. Generally, to store a data in a memorization subsystem card containing several memory chips that can store one byte words, this data is split up into bytes, the first byte is stored in a first memory chip, the second byte in a second memory chip and so on.

These memory chips are subject to different kind of failures:

soft failures that are intermittent failures due to external noisy environment, like Alpha particles, that disappear if the data word is rewritten at the failing memory location or after a memory reset.

hard failures that are permanent defects affecting a memory chip, like micro short-circuits, that remain definitively even after memory reset.

These failures, when occurring, may damage the memory system content and then disturb the correct functioning of the current application running on the computer and lead generally to stop this computer in order to replace the failing memorization subsystem card.

To get rid of these failures, Error Correcting Codes (ECC) are generally used to improve the overall memory system failure rate. Indeed, ECC have the capacity to correct automatically errors occurring in a single memory chip without disturbing the functioning of the memory system. To do that, the ECC functions write path function and read path function, that may be located inside the memory controller, are able to detect a failing word and correct it automatically thanks to ECC bits that are stored in additional memory chips on the memorization subsystem card. For example, Single Error Correction (SEC) code can correct one error in a single memory chip, Double Error Correction (DEC) code allows to correct two errors located in the same memory chip, and finally Block Error Code (BEC) code allows to correct all errors in a single memory chip. For instance, the 8-bits Block Error Code, derived from the theory of Bose-Chaudhuri-Hocquenghem codes, is able to correct multiple errors randomly distributed in a memory chip. Using two additional bytes per 64 bits length words, this method allows to correct up to 8 bits in a memory chip that can store one byte length words.

However, as the hard failures are remaining defects, the memorization subsystem cards in which hard failures are localized need to be replaced to maintain a high availability of the memory system, i.e. to avoid memory content damages that happen when errors occur in at least two different chips of a same memorization subsystem card. In this case, the user must turn off the computer and replace the failing memorization subsystem cards. Likewise, upgrading the memory system requires to turn off the computer.

### SUMMARY OF THE INVENTION

It is therefore one of the objects of the present invention to provide an improved system for accessing a memory system comprising a plurality of memorization subsystems which increases the availability and the reliability of the computer(s) using such memorization system.

It is another object of the present invention to provide an improved system in which a memorization subsystem can be replaced without disturbing the computer.

It is still another object of the present invention to provide a method to restore the content of a memorization subsystem.

The accomplishment of these and other related objects is achieved by a system for accessing a memory, comprising a plurality of memorization subsystems, independent and removable, said memory being adapted to store words made of n unitary elements, said system comprising:

encoding means to encode each of the n unitary element words to be stored into the memory into a n+m unitary elements word, where the m unitary elements are error correction unitary elements;

word input means for applying each of the n+m elementary elements of a word to a different memorization subsystem of said plurality of memorization subsystems;

word output means for accessing each of the n+m elementary elements of a word from a different memorization subsystem of said plurality of memorization subsystems;

decoding means responsive to each n+m elementary elements word for producing an error free n unitary elements word; and,

logical insulation means and electrical insulation means associated to each memorization subsystem of said plurality of memorization subsystems, capable of insulate logically and electrically each of said plurality of memorization subsystems.

The accomplishment of these and other related objects is also achieved by a method for restoring the content of a memorization subsystem comprising the steps of:

setting an address index to zero;

reading and correcting the word localized at said address index;

writing the corrected word at the location defined by said address index;

increasing said address index by one; and,

comparing said address index to the maximum value that can be reached by said address index, if said address index has not reached said maximum value repeating the last three steps else, if said address index has reached said maximum value, ending the process.

### BRIEF DESCRIPTION OF THE DRAWINQS

The novel features believed to be characteristic of this invention are set forth in the appended claims. The invention itself, however, as well as these and other related objects and advantages thereof, will be best understood by reference to the following detailed description to be read in conjunction with the accompanying drawings, in which:

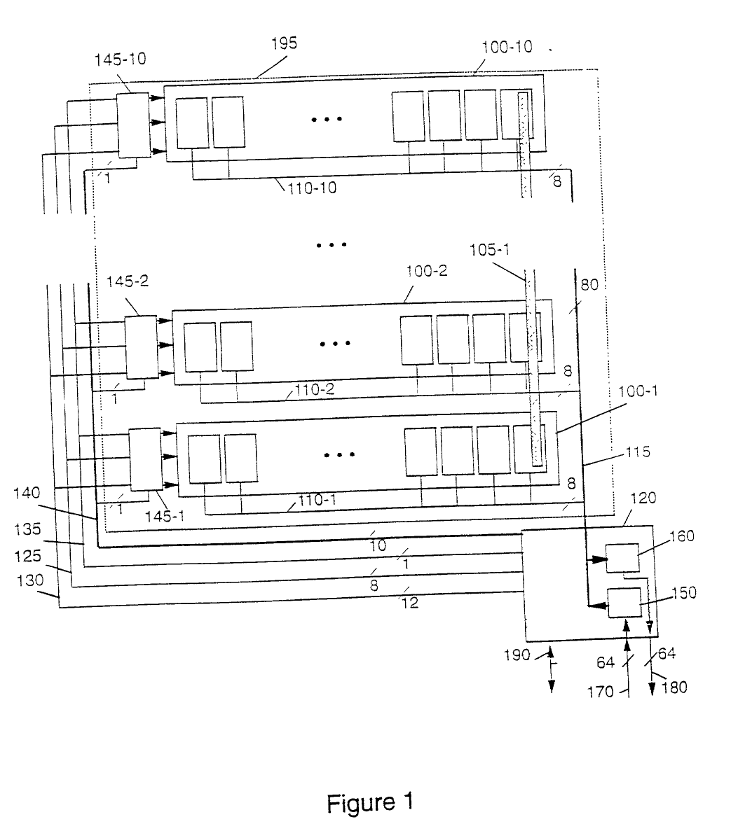

FIG. 1 shows the logical part of the circuit implementing the present invention;

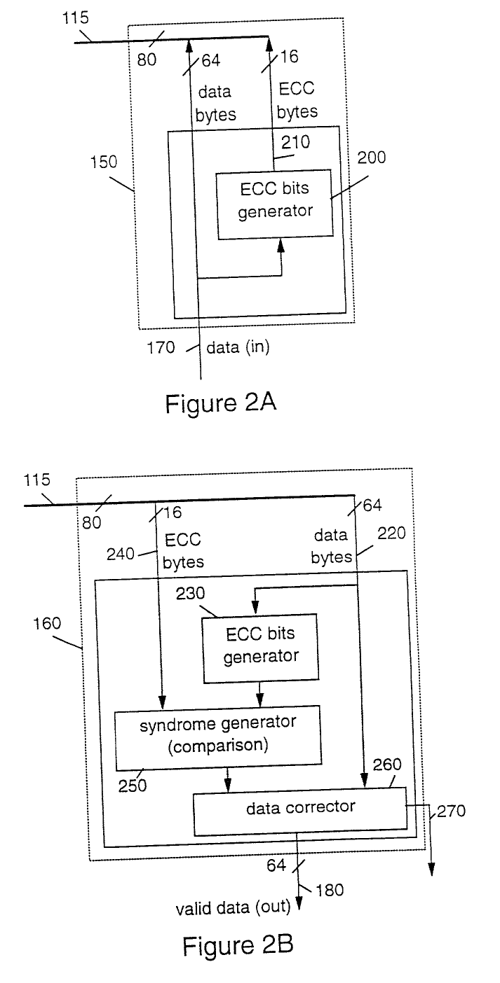

FIG. 2, comprising FIG. 2A and FIG. 2B, illustrates read and write path functions that are used to detect, localize and correct failing bits;

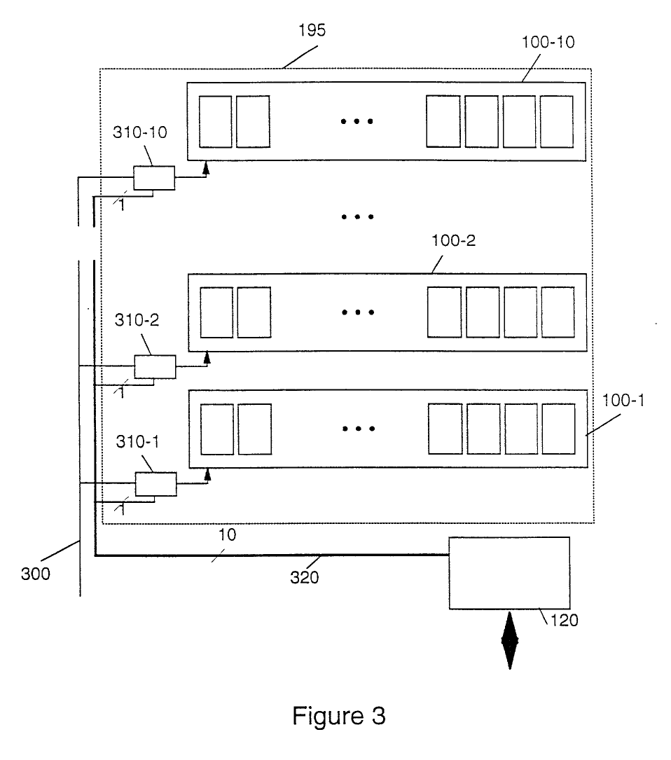

FIG. 3, illustrates the power supply circuit associated to the circuit presented in FIG. 1;

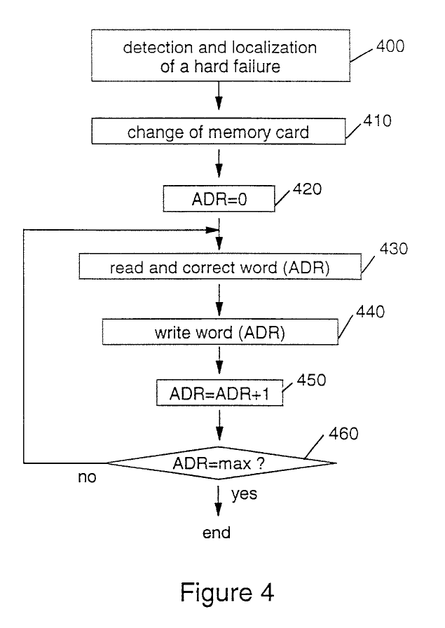

FIG. 4, shows the main steps of the algorithm that illustrates the method of the present invention; and

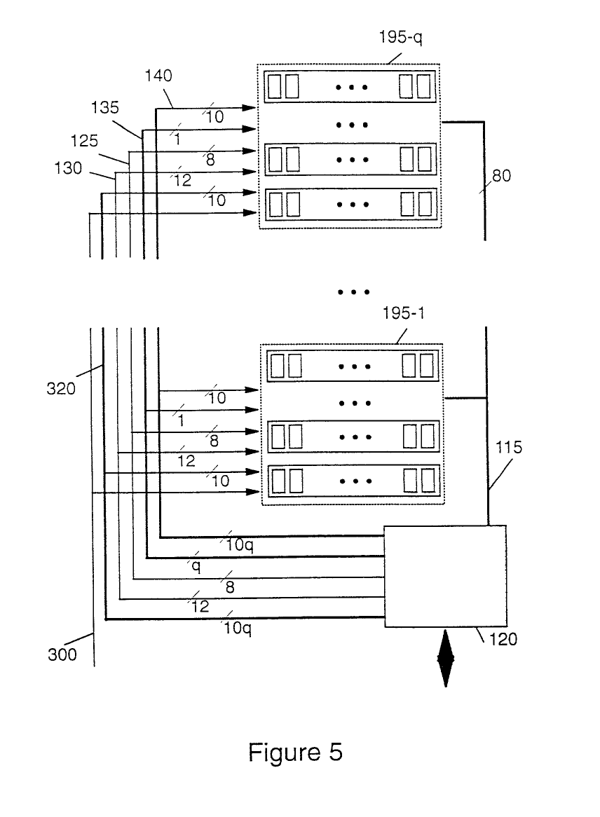

FIG. 5, shows a memory system that illustrates the way to extend the amount of memory when using the present invention.

### BEST MODE FOR CARRYING OUT THE INVENTION

According to an aspect of the invention, the words to be stored are split up into sub-words that are stored in different memorization subsystems, independent and removable. Thus, the first sub-word is stored in a first memorization subsystem, the second sub-word is stored in a second memorization subsystem and so on.

One embodiment of the present invention concerns the use of memorization subsystems, e.g. standard DIMMs, referred to as memory cards for sake of clarity, to store 64 bits words. Nevertheless, it is to be understood that the present invention can be put in use with whatever kind of independent and removable memory to store any length words.

Using the present invention to store 64 bits words, ten memory cards containing memory chips able to store r bytes are required. The first eight memory cards are used to store the data bytes while the last two memory cards are used to store the BEC bytes.

FIG. 1 shows the logical parts of the circuit implementing the present invention that allows to replace a failing memory card without perturbing the computer. As mentioned above, this circuit comprises ten memory cards 100-1 to 100-10. The data input/output buses of the memory chips contained within each memory card are connected together to create the data input/output buses 110-1 to 110-10 that form a global data input/output bus 115 connected to the memory controller 120. The memory controller 120 is also connected to BYTE_Select bus 125, address bus 130, Memory_Card_Select bus 135 and Bus_Insulation bus 140 that are connected to bus-switch components 145-1 to 145-10. Each of these bus-switch components is associated to one memory card to provide or not signals carried by BYTE_Select, address and Memory_Card_Select buses depending upon the signal carried by Bus_Insulation bus. Memory controller 120 contained write path and read path functions (150 and 160 respectively) that are connected to the data input/output bus 115. Write path function is connected to the standard data input bus 170 and read path function is connected to the standard data output bus 180. Memory controller 120 is connected to control bus 190. Buses 170, 180 and 190 are standard buses to connect a memory controller to a computer.

The memory cards 100-1 to 100-8 are used to store the eight data bytes of a 64 bits word and the memory cards 100-9 and 100-10 are used to store its two associated BEC bytes. For instance, the first byte of word 105-1 is stored in the first memory location of the first memory chip of the memory card 100-1, the second byte of this word is stored in the first memory location of the first memory chip of the memory card 100-2 and so on. The 8 bits input/output of all the memory chips of each memory card are connected together to create busses 110-1 to 110-10 in order to make the 80 bits bus 115 that is connected to the memory controller 120 to exchange data between the memory cards and the computer. To control the addresses and the enabled chips, the memory controller 120 uses BYTE_Select bus 125 and address bus 130. The BYTE_Select bus 125 is used to select memory chips inside a memory card thus, if the memory card comprises 8 memory chips, 8 bits are used to enable or disable each of the 8 memory chips. The address bus 130 selects one memory location in all the memory chips selected with BYTE_Select. In the implementation presented in FIG. 1 this bus comprises 12 bits because generally 12 multiplexed bits are used to define an address, i.e. to select one row and one column in a memory chip. In the present invention, all the ten memory cards 100-1 to 100-10 need to be enabled at the same time to access a complete data thus, Memory_Card_Select bus 135 that is used to activate or inhibit a memory card requires only 1 bit. In order to add or remove a memory card without perturbing the nine other, each of them needs to be electrically and logically insulated independently. Concerning the logical part of this circuit, the BUS_Insulation bus 140, connected to the memory controller 120, commands each of the standard bus-switch components 145-1 to 145-10. Thus, this bus comprises 10 bits at the output of the memory controller 120 and only 1 bit at the input of each bus-switch. To detect and correct failing words, write path function 150 and read path function 160, localized in memory controller 120, are used. The read path function 160 is also used to localize a failing memory card and to forewarn the memory controller 120. As mentioned above, errors due to soft failures disappear when the data is rewritten. Thus, a test consisting in rewriting the data may be performed to detect whether the error is a soft failure or a hard failure. If a hard failure is detected, the memory controller 120 could automatically insulate this failing memory card using Bus_Insulation bus 140 so that the computer user can replace it. When a hard failure occurs, the memory controller 120 sends a message through bus 190 to the computer to inform the user which memory card needs to be replaced. Bus 190 in conjunction with Bus_Insulation bus 140 also allows the computer user to inhibit a memory card so that he may change a memory card after a hard failure has been detected or for maintenance tasks. The memory system 195, that will be referred to as a memory block, allows to replace a memory card without perturbing the computer.

FIGS. 2A and 2B illustrate the circuits of the write path function and read path function respectively.

The write path function contains an ECC bits generator 200 which input is the standard data input bus 170 and output is bus 210 connected to the data input/output bus 115. The standard data input bus 170 is also connected to the data input/output bus 115.

The write path function 150, schematically presented in FIG. 2A, uses the 64 bits of the data transferred from the computer to the data memory through the standard data input bus 170 to compute 16 BEC bits in the ECC bits generator 200 that are stored in the BEC memory thanks to bus 210. Thus, the data and the corresponding ECC are addressed to the memory cards through data input/output bus 115.

The read path function 160 contains an ECC bits generator 230 which the input is connected to the data input/output bus 115 through bus 220 and the output is connected to an input of a syndrome generator 250. The syndrome generator is provided with a second input that is connected to the data input/output bus 115 through bus 240. The read path function 160 also contains a data corrector 260 which an input is connected to the output of the syndrome generator 250 and the second input is connected to the data input/output bus 115 through bus 220. An output of the data corrector is the standard data output bus 180 and the second output is BYTE_in_error bus 270.

To generate a valid data, i.e. a data without error, the read path function 160, schematically presented in FIG. 2B, accesses the data through the standard data input/output bus 115 and bus 220 and re-computes its corresponding BEC bits in the ECC bits generator 230. Then, it compares these evaluated BEC bits with the ones previously stored in the BEC memory and associated to this data, obtained through the standard data input/output bus 115 and bus 240, in the syndrome generator 250. According to the result of this comparison, the data is corrected or not in the data corrector 260. The localization of a failing byte can be obtain through BYTE_in_error bus 270. The 64 bits valid word is obtained on the standard data output bus 180.

FIG. 3 illustrates the power supply circuit of the memory block 195 that still contained ten memory cards to 100-10. A common power supply bus 300 is connected to power control modules 310-1 to 310-10 that are linked to memory cards 100-1 to 100-10, one power control module is associated to one memory card, e.g. power control module 310-1 is connected to memory card 100-1. These power control modules, acting like a bus-switch, are controlled by the memory controller 120 thanks to POWER_Enable bus 320. POWER_Enable bus 320 contains 10 bits at the output of the memory controller 120 and 1 bit at the input of each power control module so that each memory card can be electrically insulated without perturbing the others.

To avoid electronic damage, power supply and logical parts of a circuit are generally switched in two steps thus, in one embodiment, two controls, POWER_Enable and BUS_Insulation, have been used. However, these two controls could be the same. Likewise, it could be possible to use one bus-switch per memory card to insulate it logically and electrically.

To illustrate the above mentioned circuit, let us consider that memory card 100-2 is failing (hard failure). Thanks to the data bytes contained in memory cards 100-1 and 100-3 to 100-8, thanks to the BEC bytes contained in memory cards 100-9 and 100-10 and thanks to the read path function 160 comprised in the memory controller 120, the unreachable bytes stored in memory card 100-2 can be retrieved. As mentioned above, a test consisting in rewriting the data may be performed to detect whether the error is a soft failure or a hard failure. As a hard failure is detected in this example, the memory card 100-2 is to be replaced. Then, using BUS_Insulation 140 and POWER_Enable 320, memory card 100-2 can be logically and electrically insulated and thus replace by a new memory card without perturbing the computer.

FIG. 4 shows the main steps of the algorithm that illustrates one method of the present invention used in conjunction with the circuit presented in FIG. 1. It represents the restore procedure of the content of a failing memory card. After having detected and localized a hard failure in a memory card using read path function 160 and the above mentioned data rewriting test (box 400), the system forewarns the user that this memory card needs to be replaced and may logically and electrically insulate it. Thus, the user can replace the memory card (box 410). Then an address index ADR is set to zero (box 420). For sake of clarity, it is assumed that ADR index is a representation of a memory card address, i.e. an address defined by BYTE_Select bus (125) and address bus (130) signals. The word localized at address ADR is read and corrected (box 430). The byte coming from the memory card that has been replaced is not correct, however, as explained above, the coding system allows to retrieve it thanks to ECC. The corrected byte is then written at address ADR in the memory card that has been replaced (box 440). The address ADR is then incremented by 1 (box 450). A test is performed to check if the address ADR is the maximum address that can be used (box 460). If no, a loop is performed to restore the byte located at address ADR in the memory card that has been replaced (box 430 to 460). If ADR has reached its maximum value the process is stopped.

The method presented on FIG. 4 shows how the content of a memory card that has been replaced may be restored. However, it is to be understood that the method could be used to control the content of memory cards at any time. Particularly, it could be useful from time to time, e.g. when the computer memory system is not used, to control the content of the computer memorization means. This may suppress potential soft failures. Thus, it reduces the probability that errors occur at the same location in two different memory cards that could lead to a general system failure (the BEC is not able to correct such kind of error). In this case, the memory system read all the words contained in the memory system and, if an error occurs, it corrects it and writes the correction in the corresponding memorization means. This could be either periodically executed when the memory system is not used or executed on the user request. Thus, each memory card is periodically controlled and corrected if needed. Likewise, this method could be used to upgrade the memory cards without turning off the computer.

FIG. 5 shows a memory system that illustrates the way to increase the computer amount of memory using the present invention. Several above described memory block 195 are connected in parallel (195-1 to 195-q) using the common data bus 115 that is connected to the memory controller 120. The power supply 300, the address bus 130 and the BYTE_Select bus 125 are common for all the memory blocks. The POWER_Enable and the BUS_Insulation busses (320 and 140 respectively) control each memory card independently so they contain 10q bits at the output of the memory controller 120 and 10 bits at the input of each memory block. The Memory_Card_Select is used to enable or disable all the memory cards of a memory block, so Memory_Card_Select bus 135 now comprises q bits at the output of the memory controller 120 and 1 bit at the input of each memory block.

Using the circuit presented in FIG. 5, the access to any memory block 195-i for read or write operations is performed by enabling all the memory cards belonging to this memory block and disabling all the other memory cards using Memory_Card_Select bus 135 that is managed by memory controller 120. The memory access inside a memory block is performed by memory chip selections and addresses as explained above. When the read path function detects and corrects a failing word, the memory controller 120 could detect whether or not the error is a hard failure and use the information given by the data corrector to insulate the failing memory card and to inform the user through the computer. Thus, the user may replace this failing memory card without perturbing the memory system.

While the invention has been described in terms of one embodiment, those skilled in the art will recognize that the invention can be practiced with other kinds of removable and independent memorization subsystems and for other tasks. In particular, the invention can be useful to upgrade the memory system where the memory cards can be replaced one by one by memory cards having greater capacities or for preventive maintenance, without turning off the computer.

The present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

What is claimed is:

1. A system for accessing a memory comprising a plurality of memorization subsystems, independent and removable, said memory being adapted to store words made of n unitary elements, said system comprising:
encoding means to encode each of the n unitary element words to be stored into the memory into a n+m unitary elements word, where the m unitary elements are error correction unitary elements;
word input means for applying each of the n+m elementary elements of a word to a different memorization subsystem of said plurality of memorization subsystems;
word output means for accessing each of the n+m elementary elements of a word from a different memorization subsystem of said plurality of memorization subsystems;
decoding means responsive to each n+m elementary elements word for producing an error free n unitary elements word; and
logical insulation means and electrical insulation means associated to each memorization subsystem of said plurality of memorization subsystems, capable of insulate logically and electrically each of said plurality of memorization subsystems.

2. The system of claim 1 further comprising information means associated to said decoding means to forewarn the user of said system when at least one of said plurality of memorization subsystems is failing.

3. The system of claim 1 further comprising information means associated to said decoding means to forewarn the user of said system when a hard failure is detected in at least one of said plurality of memorization subsystems.

4. The system of claim 1 further comprising control means associated to said logical and electrical insulation means so that the user of said system can insulate anyone of said plurality of memorization subsystems.

5. The system of claim 1 further comprising information means associated to said decoding means and control means associated to said logical and electrical insulation means so that a failing memorization subsystem of said plurality of memorization subsystems is automatically insulated and so that the user of said system is informed that said failing memorization subsystem is failing and that said failing memorization subsystem is insulated.

6. The system of claim 1 further comprising information means associated to said decoding means, control means associated to said logical and electrical insulation means so that a failing memorization subsystem of said plurality of memorization subsystems in which a hard failure is detected is automatically insulated and so that the user of said system is informed that said failing memorization subsystem is failing and that said failing memorization subsystem is insulated.

7. The system according to claim 1 wherein the encoding means and decoding means use the 8-bits Block Error Coding algorithm.

8. The system according to claim 1 wherein said memorization subsystems of said plurality of memorization subsystems are standard Dual In-line Memory Modules.

9. A method for restoring the content of one of a plurality of memorization subsystems, comprising:
a. setting an address index to zero;
b. reading and correcting the word localized at said address index;
c. writing the corrected word at the location defined by said address index;
d. increasing said address index by one; and,
e. comparing said address index to the maximum value that can be reached by said address index, if said address index has not reached said maximum value repeating the last three steps else, if said address index has reached said maximum value, ending the process.

10. The method of claim 9 wherein the step c comprises writing at least one unitary element of said corrected word in at least one of said plurality of memorization subsystems.

11. The method according to claim 10 wherein the step c comprises writing at least one unitary element of said corrected word in at least one of said plurality of memorization subsystems if an error has been detected in said at least one unitary element of said corrected word.

12. The method according to claim 11 wherein said steps a to e are performed when the memory system is not used.

13. The method according to claim 11 wherein said steps a to e are performed on user request.

14. The method according to claim 9 wherein the step c comprises writing at least one unitary element of said corrected word in at least one of said plurality of memorization subsystems if an error has been detected in said at least one unitary element of said corrected word.

15. The method according to claim 9 wherein said steps a to e are performed when the memory system is not used.

16. The method according to claim 9 wherein said steps a to e are performed on user request.

17. At least one program storage device readable by a machine, tangibly embodying at least one program of instructions executable by the machine to perform a method for restoring the content of one of a plurality of memorization subsystems comprising:
a. setting an address index to zero;
b. reading and correcting the word localized at said address index;
c. writing the corrected word at the location defined by said address index;
d. increasing said address index by one; and,
e. comparing said address index to the maximum value that can be reached by said address index, if said address index has not reached said maximum value repeating the last three steps else, if said address index has reached said maximum value, ending the process.

18. The at least one program storage device of claim 17 wherein the step c comprises writing at least one unitary element of said corrected word in at least one of said plurality of memorization subsystems.

19. The at least one program storage device according to claim 17 wherein the step c comprises writing at least one unitary element of said corrected word in at least one of said plurality of memorization subsystems if an error has been detected in said at least one unitary element of said corrected word.

20. The method according to claim 17 wherein said steps a to e are performed when at least one of the memory system is not used and on user request.
